(19) United States
(12) Patent Application Publication
(10) Pub. No.: US 2022/0250027 A1
(43) Pub. Date: Aug. 11, 2022

(54) SUPPRESSION OF WATER EVAPORATION USING FLOATING LATTICE-LIKE STRUCTURES

(71) Applicant: The State of Israel, Ministry of Agriculture & Rural Development, Agricultural Research Organization, Rishon Lezion (IL)

(72) Inventors: Shmuel ASSOULINE, Mevasseret Tsion (IL); Kfir NARKIS, Yavne (IL)

(21) Appl. No.: 17/626,137

(22) PCT Filed: Jul. 13, 2020
(86) PCT No.: PCT/IB2020/056545

§ 371 Date: Jan. 11, 2022

Related U.S. Application Data
(60) Provisional application No. 62/967,622, filed on Jan. 30, 2020.
(60) Provisional application No. 62/872,711, filed on Jul. 11, 2019.

(51) Int. Cl. B01J 19/16

(52) U.S. Cl. CPC B01J 19/16; B65D 90/42

(57) ABSTRACT

A floating element configured for inhibiting wind flow across a body of liquid so as to suppress liquid evaporation including: a lattice-like structure configured for floating in the body of liquid, the lattice-like structure includes a plurality of elongated portions and joints and a plurality of inner connections configured for creating a plurality of substructure components joined to one another so as to form at least substantially a cubic structure.

### CROSS-REFERENCES TO RELATED APPLICATIONS

This application is related to and claims priority from commonly owned US Provisional Patent Applications: 1) U.S. Provisional Patent Application Ser. No. 62/872,711, entitled: Evaporation suppression from water reservoirs using minimal cover, filed on 11 Jul. 2019; and, 2) U.S. Provisional Patent Application Ser. No. 62/967,622, entitled: Evaporation suppression from water reservoirs using minimal cover, filed on Jan. 30, 2020, both of the disclosures of which are incorporated by reference herein.

### TECHNICAL FIELD

The present invention relates to the field of water evaporation.

### BACKGROUND OF THE INVENTION

Freshwater is a crucial element for human life, economic development, food production, sanitation, health, and welfare. However, freshwater resources are decreasing globally. Most, if not all, of the freshwater used by humans is stored with relatively short retention times in rivers, lakes, seasonal snow, and soil moisture. Therefore, water management activities, such as irrigation, municipal water supply, hydropower generation, and flood control, are improved by altering the natural freshwater fluxes at the land surface through the construction of artificial surface water storage via dams and reservoirs.

To meet the steadily increasing demand for food for the growing global population, irrigated agriculture is expanding. Since the early 1900s, the global irrigated agricultural area has increased six-fold. To accommodate this rapid increase in irrigation water demand, tens of thousands of dams and millions of reservoirs have been built globally during the past half-century. These structures are estimated to have a cumulative storage capacity of 7000 to 8300 km³, nearly 10% of the water stored in all-natural freshwater lakes on Earth.

A crucial first step in most scenarios addressing water scarcity is the reduction of water losses, especially those due to evaporation from water bodies. The amount of stored water lost to evaporation depends on many factors including atmospheric evaporative demand, reservoir size, and method of storage. Numerous attempts have been made to reduce evaporation losses from reservoirs such as increasing depth, installing windbreaks, or covering the water surface.

### SUMMARY OF THE INVENTION

The present invention introduces a floating lattice-like element for inhibiting wind flow across a body of liquid so as to suppress liquid evaporation. The floating element of the present invention floats in a body of liquid and causes a significant decrease to the wind velocity at the liquid surface, thus reducing the evaporation rate from the covered body of liquid, while allowing free transmission of light and a full exchange of gas, especially oxygen, between air and body of liquid.

Embodiments of the invention are directed to a floating element configured for inhibiting wind flow across a body of liquid so as to suppress liquid evaporation comprising: a lattice-like structure configured for floating in the body of liquid, the lattice-like structure includes a plurality of elongated portions and joints and a plurality of inner connections configured for creating a plurality of substructure components joined to one another so as to form at least substantially a cubic structure.

Optionally, the cubic structure is a square.

Optionally, the cubic structure is a rectangular.

Optionally, the plurality of substructure components are square shaped.

Optionally, the plurality of substructure components are triangular in shape.

Optionally, the lattice-like structure is made of a floatable material.

Optionally, the lattice-like structure is in communication with at least one buoyancy components so as to float in the body of liquid.

Optionally, the body of liquid is freshwater.

Embodiments of the invention are directed to a system for suppressing water evaporation comprising: a reservoir holding a volume of liquid; and, at least one floating element in the volume of liquid, the at least one floating element includes a lattice-like structure including a plurality of elongated portions and joints and a plurality of inner connections configured for creating a plurality of substructure components joined to one another so as to form at least substantially a cubic structure.

Optionally, the at least one floating element includes a plurality of floating elements.

Optionally, the at least one floating element covers at least a portion of the liquid.

Optionally, the cubic structure is a square.

Optionally, the cubic structure is a rectangular.

Optionally, the plurality of substructure components are square shaped.

Optionally, the plurality of substructure components are triangular in shape.

Optionally, the lattice-like structure is made of a floatable material.

Optionally, the lattice-like structure is in communication with at least one buoyancy components so as to float in the body of liquid.

Optionally, the lattice-like structure is of colors configured to repel fish-eating birds.

Optionally, the lattice-like structure is white.

Optionally, the volume of liquid is freshwater.

Embodiments of the invention are directed to a method for suppressing water evaporation comprising: providing a volume of liquid into a reservoir; placing at least one floating element in the volume of liquid, the at least one floating element includes a lattice-like structure including a plurality of elongated portions and joints and a plurality of inner connections configured for creating a plurality of substructure components joined to one another so as to form at least substantially a cubic structure.

“Lattice-like structure” as used herein, refers to a multi-dimensional, preferable three-dimensional, structure consisting of a repeated sub-unit forming a pattern of a lattice.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIGS. 1A and 1B are side views of floating elements according to different embodiments of the present invention;

FIG. 2 is a top left view of floating elements having lattice-like structures with different porosity according to different embodiments of the present invention;

FIG. 3 is a side view of a system for suppressing water evaporation according to an embodiment of the present invention;

FIGS. 4A-4C are schematic illustrations of an experimental set-up for evaluating the concept of suppressing evaporation using a floating element according to an embodiment of the present invention;

FIGS. 5A-5B present the horizontal wind velocity profiles above the water surface of an uncovered reservoir and of a reservoir covered with a floating element according to an embodiment of the present invention;

FIGS. 6A-6C are graphs presenting the evaporation rates, the ratio between evaporation rates, and the ratio between estimated resistance of the boundary layers of a covered and uncovered reservoir in different wind velocities;

FIGS. 7A-7B are graphs presenting the measured water surface temperature of a covered and uncovered reservoir compared to the air temperature with no wind and with a wind speed of 3.5 m/s.

FIG. 8 is a graph presenting the distribution of the difference between water temperature after 4 days of evaporation and the initial water temperature as function of depth of a covered and uncovered reservoir;

FIGS. 9A-9C are graphs presenting the evaporation rates, the ratio between evaporation rates, and the ratio between estimated resistance of the boundary layers of a reservoir covered with opaque black balls and a reservoir covered with a floating element according to an embodiment of the present invention in different wind velocities;

FIGS. 10A-10B are graphs presenting the water surface temperature of a reservoir covered with opaque black balls and a reservoir covered with a floating element according to an embodiment of the present invention in two wind velocities;

### DESCRIPTION OF THE PREFERRED EMBODIMENTS

The principles and operation of the present invention may be better understood with reference to the drawings and the accompanying description.

Before explaining at least one embodiment of the invention in detail, it is to be understood that the invention is not necessarily limited in its application to the details of construction and the arrangement of the components and/or method set forth in the following description and/or illustrated in the drawings and/or Examples. The invention is capable of other embodiments or of being practiced in various ways.

By way of introduction, most floating elements used to cover water surfaces and suppress evaporation losses are opaque, providing a partial or full cover of the water surface.

Since evaporation from free water surface occurs at its potential rate, one would expect evaporation losses to be proportional to the evaporating area, and consequently, water saving would be proportional to the percentage of the covered area. However, a partial or full cover of free water surface affects both heat and mass exchange resulting in a nonlinear relationship between the covered surface fraction and evaporation suppression.

While suppressing evaporation, opaque floating elements assembled on a water reservoir also reduce solar radiation, light transmission, and gas exchange as they prevent any interaction between the water and the external environment. Temperature, light, and oxygen are crucial factors affecting life and water quality. Some positive effects could be attributed to the lack of light (prevention of the growth of toxic algae) or to the cooler water resulting from the prevention of solar radiation (an increase of dissolved oxygen in the cooler water), however, it is well accepted that reducing light transmission and oxygen supply affect the occurrence of chemical reactions as well as the life of aerobic organisms within the water causing a reduction in water quality (dead algae secrete algal toxins).

Furthermore, many small reservoirs storing water for irrigation have dual functions as they also serve to grow fishes until the water is released for irrigation. Such fish growing reservoirs require light and oxygen.

Evaporation from a free water surface can be described as a mass transfer process, which is typically a turbulent transport of vapor by eddy diffusion across the boundary layer above the free water surface. The rate of evaporation from a free water surface, e, represents the ability of the atmosphere to uptake water vapor. It is, therefore, dependent on the effectiveness by which water vapor can be removed from the evaporating surface, expressed by the resistance of the boundary layer to the vapor flow, r_{BL}:

$$e = \frac{( P {v}_{s} - P {v}_{a} )}{{r}_{B L}} \qquad ( Eq . 1 )$$

where Pvₛ and Pvₐ are the saturated vapor pressure and air vapor pressure, respectively. The difference(Pvₛ−Pvₐ), is the vapor pressure deficit of the air (VPD), and it determines the driving force of evaporation. When the VPD is expressed in [Pa] and e in [W/m²], then the units of r_{BL} are [s/m]. According to Fick's law, the resistance of the boundary layer, r_{BL}, in Eq. (1), can be estimated by:

$${r}_{B L} = \frac{δ}{D} \qquad ( Eq . 2 )$$

where D is the vapor diffusion coefficient [m²/s] and δ is the thickness of the boundary layer [m]. The variable δ is related to the wind speed, U:

δ∝(U^{-0.5}) (Eq. 3)

As a result, reducing wind speed increase the thickness of the boundary layer (Eq. 3), and consequently its resistance (Eq. 2), thus reducing the resulting evaporation rate for a given VPD (Eq. 1).

The present invention introduces a floating element for inhibiting wind flow across a body of liquid so as to suppress liquid evaporation. The floating element of the present invention floats in a body of liquid and causes a significant decrease to the wind velocity at the liquid surface, thus reducing the evaporation rate from the covered body of liquid, while allowing free transmission of light and a full exchange of gas, especially oxygen, between air and body of liquid.

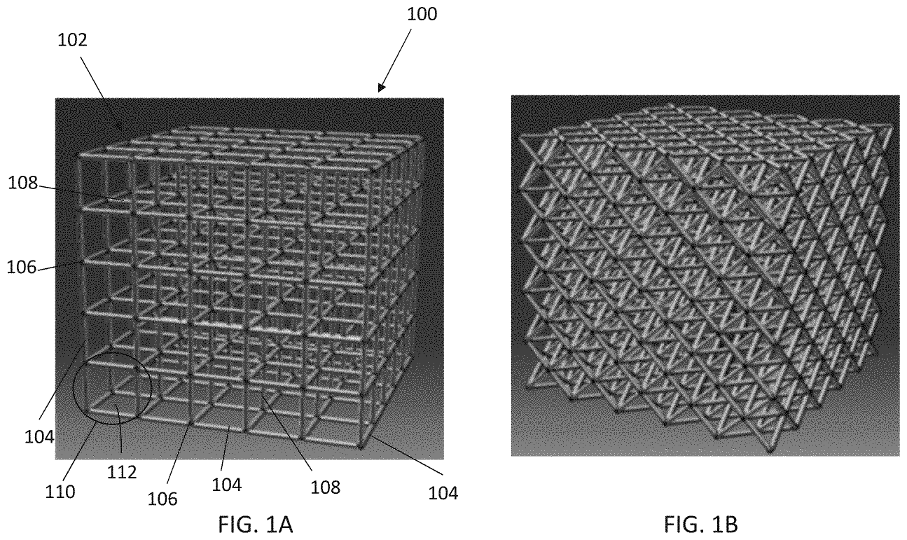

FIG. 1A is a side view of floating element 100. Floating element 100 includes, for example, a lattice-like structure 102 made of a plurality of elongated portions 104, joints 106, and inner connections 108. The plurality of elongated portions 104, joints 106, and inner connections 108, which are, for example, made of a floatable material such as light metals, plastic, wood, Styrofoam and the like form a plurality of substructure components 110 that are joined to one another so as to form, for example, a cubic structure.

The plurality of substructure components 110 include gaps 112 and can be of various geometrical shapes, such as, triangular, rectangular, octet (FIG. 1B), hexagonal, and the like so as to provide the same impact on wind velocity independent of wind direction.

In another embodiment, the plurality of elongated portions 104, joints 106, and inner connections 108 are made of a non-floating material such as aluminum and the like and are connected to buoyancy components, such as a float and the like, so as to allow the lattice-like structure 102 to float in a volume of liquid.

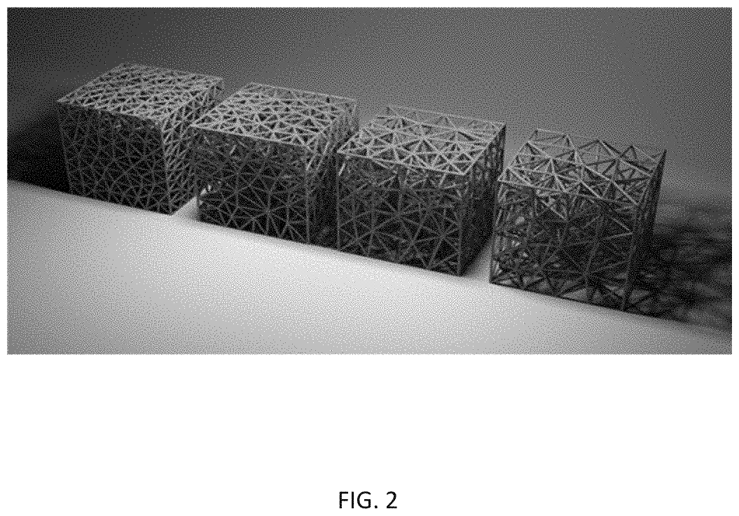

The dimensions of the lattice-like structure 102, for example, joint radius, structure size and especially its height and porosity (affected by the number of substructure components in each face), determine its impact in relation to suppressing evaporation as they affect the boundary layer characteristics at the evaporating water surface vicinity. Similar structures of lattice-like structure 102 with different porosity, and consequently, of different characteristics, as best seen in FIG. 2, are fitted for different climatic and environmental conditions. Therefore, the appropriate structure for a given site is optimized to produce the best performances.

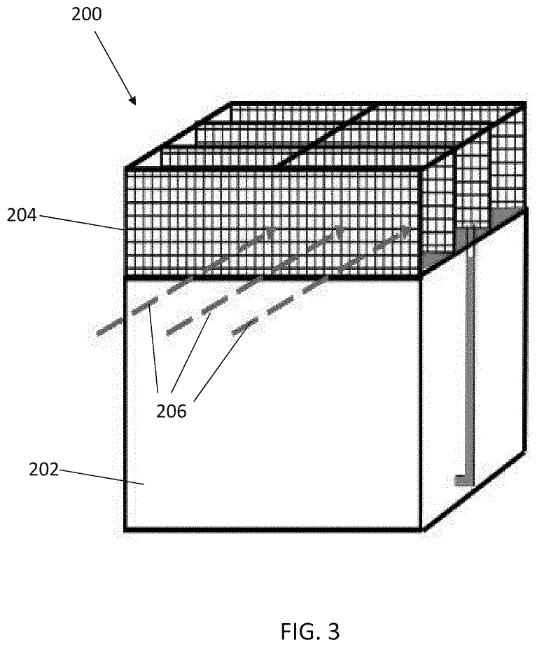

FIG. 3 is a front left view of system 200. The system 200 includes a reservoir 202 holding a volume of liquid, for example, water and a floating element 204 dispersed on the surface of the water so as to cover portions of the water surface. The floating element 204 is similar in construction and operation to floating element 100, as detailed above, except where indicated.

In operation, the floating element 204 covers only a small percentage of the water surface due to its lattice-like structure. The lattice-like structure of floating element 204 disrupts the wind flow of wind 206 at the water surface causing a reduction in wind velocity, which in turn causes a reduction in the evaporation rate of the water. Concurrently with the reduction in evaporation rate, the lattice-like structure of floating element 204 enables free transmission of light and full exchange of gas, especially oxygen, between the air and the water, thus preserving water quality.

The floating element 204 may further be of specific colors, for example, white so as to fill a dual function of suppressing evaporation and discouraging fish-eating birds from fish growing reservoirs. The specific colors repel the fish-eating birds and as a result keeps them from approaching fish growing reservoirs.

### EXAMPLES

The following examples are not meant to limit the scope of the claims in any way. The following examples are put forth so as to provide those of ordinary skill in the art with a complete disclosure and description of how to make and use the described invention, and are not intended to limit the scope of the invention, nor are they intended to represent that the experiments below are all or the only experiments performed. Unless indicated otherwise, parts are parts by weight, molecular weight is weight average molecular weight, temperature is in degrees Centigrade, and pressure is at or near atmospheric.

### Example I—Comparison Between a Covered and an Uncovered Reservoir in Relation to Wind Velocity at the Front, Middle, and Back of the Reservoirs

The concept of suppressing evaporation using a floating element with a lattice-like structure having very high porosity that covers only a few percentages of the water surface but reduces wind speed significantly and affects the properties of the boundary layer of the water was evaluated under laboratory conditions. It is possible to investigate the proposed concept on such a simple structure since the experiment was carried out under laboratory conditions where wind was generated by fans and had a constant direction perpendicular to the porosity of the structure.

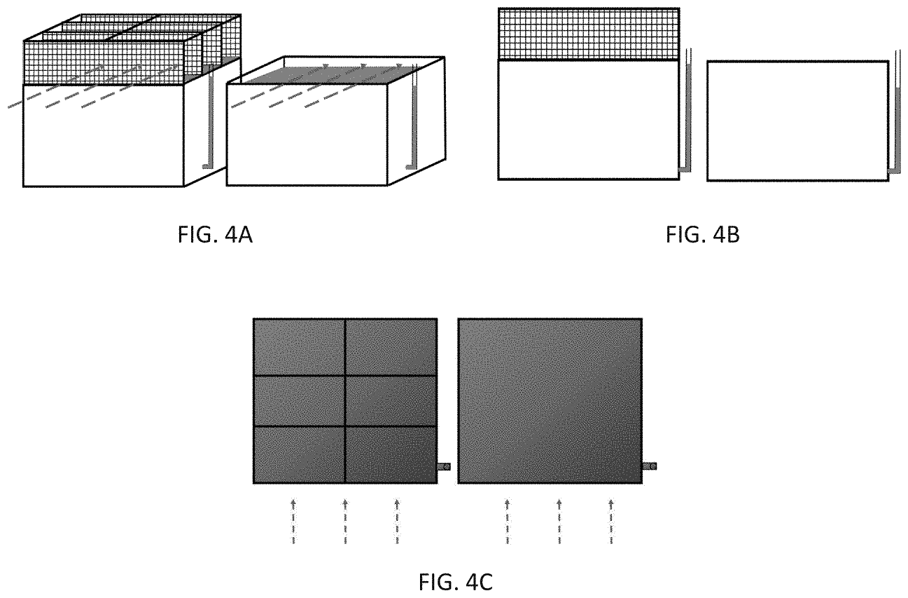

FIGS. 4A-4C are schematic representations of the experimental set-up. FIG. 4A is a front view, FIG. 4B is a side view, and FIG. 4C. is a top view.

Two reservoirs filled with water having an area of 1 m² and a depth 0.4 meter were used. A floating element according to the present invention covering 8.25% of the water surface area was positioned on one reservoir, while the other reservoir was left uncovered. The floating element was constituted using a rectangular parallelepipedic frame of 1.0 meter by 1.0 meter having a height of 0.2 meter. A set of 11 rectangular (0.2 meter by 1.0 meter) strips of a cubic plastic net of two meshes (79% of voids) and a thickness of 0.002 meter, were positioned perpendicular to the water surface every 0.1 meter along one of the axes of the frame. The resulting porosity of the floating element structure was 99.3%. Each reservoir was then exposed to two juxtaposed fans (Heavy duty 18″ fans, Briza, Israel) connected to potentiometers allowing to control the wind speed. The fans were installed 1.6 m from the front edge of the reservoirs. The floating element structure was oriented such that the net strips were perpendicular to the wind direction produced by the fans.

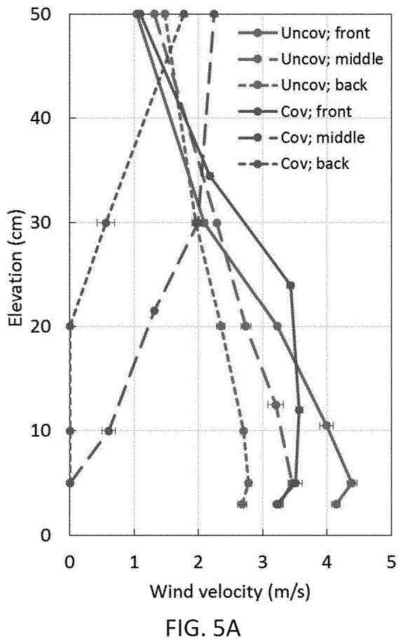

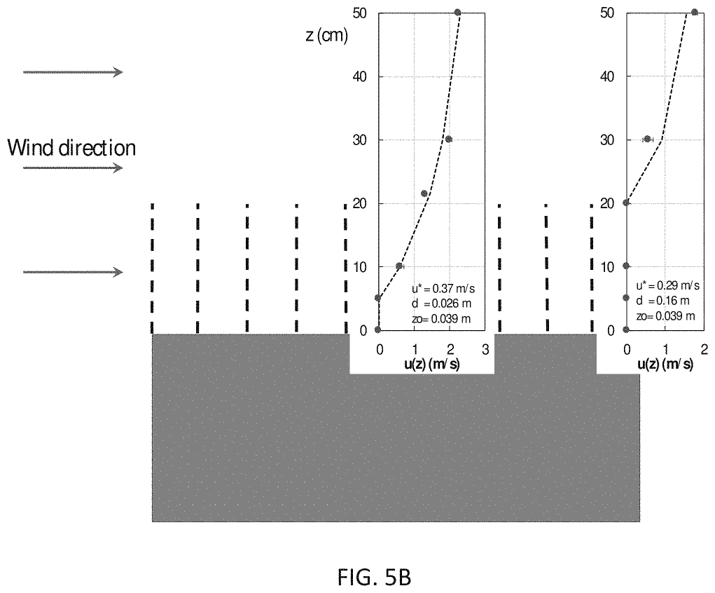

The horizontal wind velocity profiles measured at the front, middle, and back of the uncovered and the covered reservoirs generated by the experimental set-up are depicted in FIGS. 5A and 5B. For a floating element structure having a height of 20 centimeters, the horizontal wind velocity within the structure (10 cm above the water surface) at the middle of the reservoir is 17% of the velocity at the front edge. At the back of the reservoir, it is practically null within the whole structure.

Different runs applying different wind velocities were carried out in two replicates in which the covered and the uncovered reservoirs were shifted. Wind speed was measured using a velocity meter at the center of the upwind edge of each reservoir at a height corresponding to the top of the floating element structure. The water level in the reservoirs was monitored by means of a pressure transducer. A floating chain of thermocouples monitored the water temperature distribution as function of the depth change, from the water surface to the bottom of the reservoirs. Ambient air and relative humidity were monitored 1.5 m above the reservoirs. The measured data were sampled every hour and stored on a datalogger.

The data of FIGS. 5A and 5B demonstrate the effect of the floating element of the present invention on the wind velocity profile above the water surface.

### Example II—Comparison Between a Covered and an Uncovered Reservoir in Different Wind Velocities

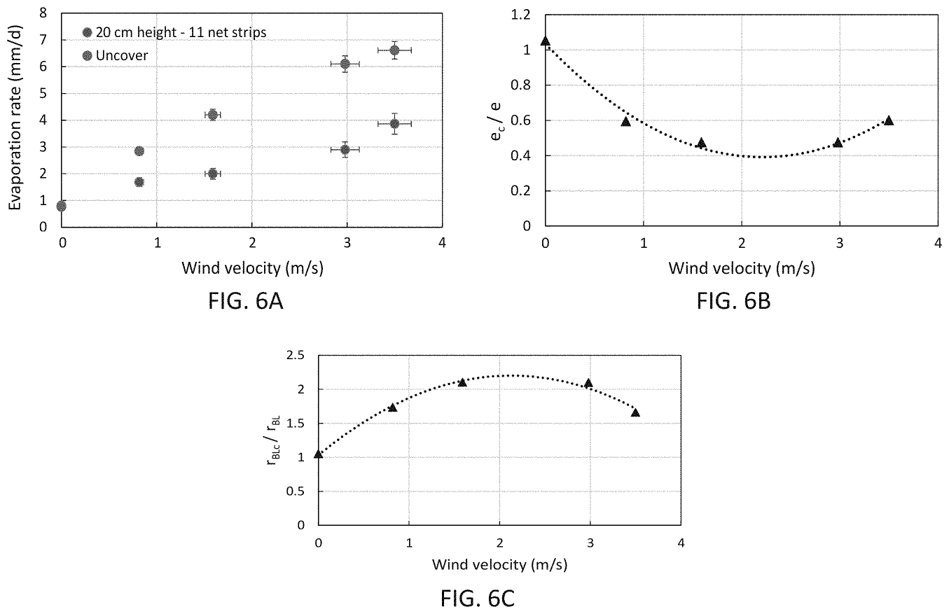

The impact of the floating element according to the present invention on the evaporation rate is depicted in FIG. 6A.

When the wind velocity is null, the floating element has no effect whatsoever on the evaporation rate as it covers only 8% of the water surface and its porosity is 99.3% allowing free passage of vapor and gas from the water to the air. Consequently, the evaporation rates from the covered and the uncovered reservoirs are identical (ec/e=1; FIG. 6B).

When the wind is blowing, the floating element reduces the wind velocity at the water surface (FIG. 5), evaporation is suppressed, and the evaporation rate, e_{c} (blue dots), of the covered reservoir is lower than the evaporation rate of the uncovered reservoir, e (red dots).

As the wind velocity increases, the evaporation rate in both configurations increases in a non-linear manner. Due to the evaporation suppression caused by the floating element structure, the ratio (e_{c}/e) is lower than 1 (FIG. 6B). This ratio varies between 0.4 to 0.6, with an apparent slight minimum (higher efficiency of the cover) around a wind velocity of 2.5 m/s, which is in line with the nonlinearity of the wind speed depicted in FIG. 6A.

The resistance of the boundary layer, r_{BL}, depicted in FIG. 6C was estimated based on Eq. 1, using the measured data of e and the corresponding VPD. The ratio between the resistances of the covered and the uncovered conditions (r_{BLc}/r_{BL}) is wind speed dependent and presents a maximum value of approximately 2 for a wind velocity of approximately 2.5 m/s (FIG. 6C). The floating element reduces the wind speed above the water surface, thus increasing the thickness of the boundary layer (Eq. 3) and consequently, its resistance (Eq. 2).

### Example III—Comparison of the Temporal Change in Water Surface Temperature Between a Covered Reservoir and an Uncovered Reservoir

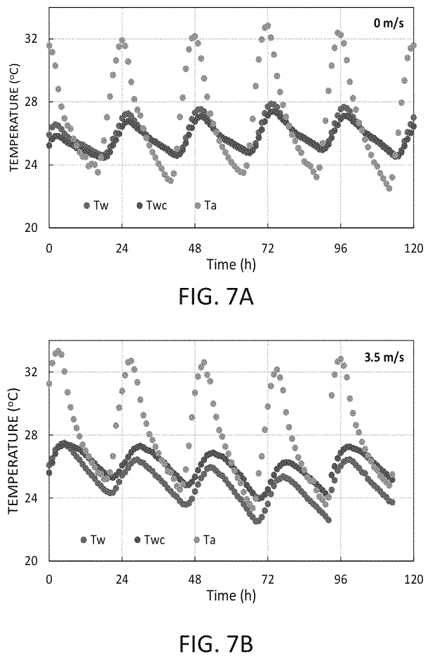

The air temperature (Tₐ) and the measured temporal change of the water surface temperature of both the covered (T_{wc}) and the uncovered (T_{w}) reservoirs are depicted in FIG. 7. The temporal change of the water surface temperature was measured in no wind conditions (FIG. 7A) and with a wind speed of 3.5 m/s (FIG. 7B).

When there is no wind, the evaporation rates of both reservoirs are practically the same (FIG. 6A) making the water surface temperatures similar as well. As the wind starts blowing, the floating element of the present invention reduces the evaporation rate (FIG. 6A) and consequently, T_{wc}>T_{w} throughout the experiment (FIG. 7B).

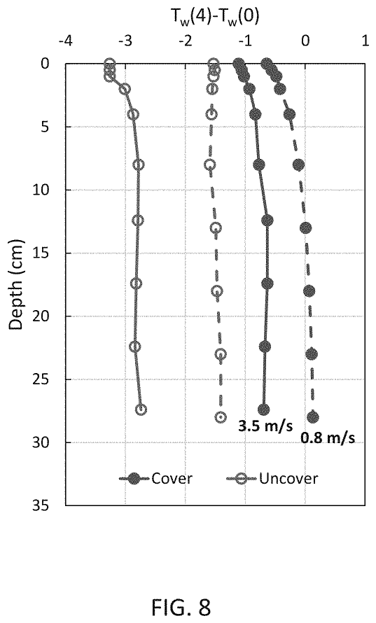

The distribution of the difference between water temperature after 4 days of evaporation, T_{w}(4), and the initial water temperature, T_{w}(0), as function of the depth in both the covered and the uncovered reservoirs for two wind velocities, 0.8 m/s and 3.5 m/s is depicted in FIG. 8.

The water in the uncovered reservoir is cooler than the water in the covered reservoir, which corresponds with the measured higher evaporation rates (FIG. 6A). The cooling effect is more important for the higher wind speed, as it intensifies the evaporation process. The results of FIGS. 7A-7B and 8 show that the floating element of the present invention affect the evaporation rate and impacts the amount of latent heat released from the water.

### Example IV—Comparison Between the Floating Element of the Present Invention and a Standard Opaque Floating Element

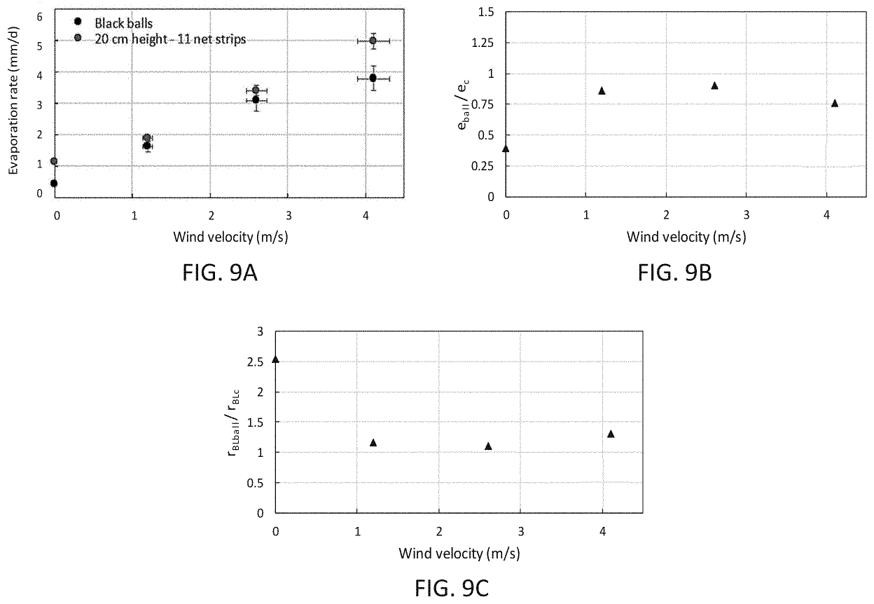

The performances of the floating element of the present invention were compared to those of a standard opaque floating element consisting of 10 cm-in-diameter black plastic balls covering the entire reservoir. As noted above, the floating element of the present invention covers about 8% of the water surface leaving about 92% of the water surface uncovered and accessible to air and light, whereas the black balls cover about 90% of the water surface. The resulting evaporation rates of both reservoirs were measured under different wind velocities and related variables (FIGS. 9A and 9C).

In the absence of wind, the black balls of the standard opaque floating element cover almost the entire water surface and are more efficient in suppressing evaporation than the floating element of the present invention (as the floating element of the present invention leaves almost the entire water surface in contact with the surrounding air) (FIG. 9A). This results a e_{ball}/e_{c} ratio of 0.34 (FIG. 9B).

When the wind is blowing, the black balls cover is still more efficient in suppressing evaporation (lower evaporation rates; FIG. 9A), but the e_{ball}/e_{c} ratio is now 0.75 or higher (FIG. 9B), indicating that the floating element of the present invention performs surprisingly well as an evaporation suppressor. This is also reflected by the resistances ratio which is close to 1.0 under different wind conditions (FIG. 9C).

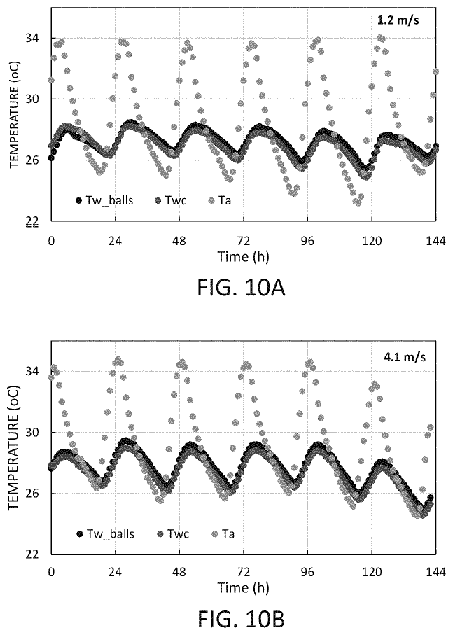

FIGS. 10A-10B demonstrate a comparison of the performances of the standard opaque floating element as opposed to those of the floating element of the present invention in relation to their impact on the water surface temperature (T_{w}) in two separate reservoirs. The air temperature (Tₐ) and the measured water surface temperatures were measured under wind velocities of 1.2 m/s and 4.1 m/s.

The water surface temperature of the reservoir covered with the opaque black balls, T_{w_ball}, is systematically higher than the temperature of the corresponding reservoir covered with the floating element of the present invention, T_{c}, which corresponds to the lower evaporation rates measured in that reservoir (FIG. 9A). However, the difference between the water surface temperatures of the two reservoir is approximately 0.4° C. for a wind velocity of 1.2 m/s and approximately 0.5° C. for a wind velocity of 4.1 m/s, which is in line with the higher difference in measured evaporation rates for the same wind velocities (FIG. 9A).

While the invention has been described with respect to a limited number of embodiments, it will be appreciated that many variations, modifications and other applications of the invention may be made. Therefore, the claimed invention as recited in the claims that follow is not limited to the embodiments described herein.

1. A floating element configured for inhibiting wind flow across a body of liquid so as to suppress liquid evaporation comprising:
a lattice-like structure configured for floating in said body of liquid, said lattice-like structure includes a plurality of elongated portions and joints and a plurality of inner connections configured for creating a plurality of substructure components joined to one another so as to form at least substantially a cubic structure.

2. The floating element of claim 1, wherein said cubic structure is a square.

3. The floating element of claim 1, wherein said cubic structure is a rectangular.

4. The floating element of claim 1, wherein said plurality of substructure components are square shaped.

5. The floating element of claim 1, wherein said plurality of substructure components are triangular in shape.

6. The floating element of claim 1, wherein said lattice-like structure is made of a floatable material.

7. The floating element of claim 1, wherein said lattice-like structure is in communication with at least one buoyancy components so as to float in said body of liquid.

8. The floating element of claim 1, wherein said body of liquid is freshwater.

9. A system for suppressing water evaporation comprising:
a reservoir holding a volume of liquid; and,
at least one floating element in said volume of liquid, said at least one floating element includes a lattice-like structure including a plurality of elongated portions and joints and a plurality of inner connections configured for creating a plurality of substructure components joined to one another so as to form at least substantially a cubic structure.

10. The system of claim 9, wherein said at least one floating element includes a plurality of floating elements.

11. The system of claim 9, wherein said at least one floating element covers at least a portion of said liquid.

12. The system of claim 9, wherein said cubic structure is a square.

13. The system of claim 9, wherein said cubic structure is a rectangular.

14. The system of claim 9, wherein said plurality of substructure components are square shaped.

15. The system of claim 9, wherein said plurality of substructure components are triangular in shape.

16. The system of claim 9, wherein said lattice-like structure is made of a floatable material.

17. The system of claim 9, wherein said lattice-like structure is in communication with at least one buoyancy components so as to float in said body of liquid.

18. The system of claim 9, wherein said lattice-like structure is of colors configured to repel fish-eating birds.

19. The system of claim 18, wherein said lattice-like structure is white.

20. The system of claim 9, wherein said volume of liquid is freshwater.

21. A method for suppressing water evaporation comprising:
providing a volume of liquid into a reservoir;
placing at least one floating element in said volume of liquid, said at least one floating element includes a lattice-like structure including a plurality of elongated portions and joints and a plurality of inner connections configured for creating a plurality of substructure components joined to one another so as to form at least substantially a cubic structure.
